(19) United States
(12) Patent Application Publication
(10) Pub. No.: US 2026/0338205 A1
(43) Pub. Date: Oct. 29, 2026

(54) Supply Device

(71) Applicant: Nordhydraulic AB, Kramfors (SE)

(72) Inventor: Bertil Lundgren, Bjärtra (SE)

(73) Assignee: Nordhydraulic AB, Kramfors (SE)

(21) Appl. No.: 19/110,545

(22) PCT Filed: Nov. 10, 2023
(86) PCT No.: PCT/EP2023/081406

§ 371 Date: Mar. 11, 2025

(30) Foreign Application Priority Data
Nov. 23, 2022 (DE) 10 2022 004 376.9

(51) Int. Cl. F15B 11/17; F15B 11/042

(52) U.S. Cl. CPC F15B 11/17; F15B 11/0426

(57) ABSTRACT

The disclosure relates to a supply device for at least one hydraulic load, such as a working cylinder, comprising a fluid supply device, which is connected to a supply circuit that has at least two fluid pumps, for the respective hydraulic load, a controller which controls the supply of fluid to the respective hydraulic load in the inlet, and at least one regulating device. Outlet sides of each of the fluid pumps are connected to the inlet of the fluid supply by means of the controller, thereby bypassing the regulating device, and each regulating releases a modifiable opening cross-section, which can be connected to each of the outlet sides of the fluid pumps in the return feed line from the respective load in order to form a low-pressure or return connection.

### CROSS-REFERENCE TO RELATED APPLICATIONS

This application claims priority to German Patent Application DE 10 2022 004 376.9, filed on Nov. 23, 2022 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a supply device for at least one hydraulic consumer, such as a working cylinder, comprising a fluid supply device which is connected to a supply circuit that has at least two fluid pumps, for the respective hydraulic consumer, an open-loop control device which controls the supply of fluid to the respective hydraulic consumer in the inlet, and at least one closed-loop control device.

A wide range of different closed-loop control devices for hydraulic feed or fluid pumps are known in prior art, such pumps being limited, on the one hand, by the maximum displacement volume and the maximum possible drive speed in relation to the geometric configuration or with regard to the achievable stability of moving pump elements.

Thus, a prior art according to FIG. 1 relates to a so-called directly controlled power regulator. In this case, the volume flow provided is adjusted to the volume flow required by the consumer by controlling the volume flow, e.g., via the swivel angle adjustment on the fluid pump. The pressure at the fluid pump is increased by the drop in pressure via a measuring orifice as part of a control device. The required power of the consumer corresponds to the power at the fluid pump plus a power loss via the said measuring orifice. This known system solution is very energy-efficient; however, the swivel angle pumps used are very expensive to purchase.

Overall, the known regulator forms a so-called load-sensing regulator (LS regulator), which adjusts the pump feed or volume flow and the pump pressure to the power requirement of the hydraulic consumer, any power losses being reduced. The term load-sensing (LS) is used since the regulating system always requires an LS pressure for it to function, with the result that a pump pressure in excess of the actual consumer pressure is required.

For this purpose, FIG. 2 shows an alternative solution in prior art and instead of an LS regulator for a swivel angle pump, a circulating pressure compensator is used as the regulator. In this system solution, the maximum volume flow is always provided by the fluid pump. The volume flow not required by the hydraulic consumer is discharged via the circulating pressure compensator to a low-pressure side or to the tank. This means that the power that is not required is converted into heat and is thus lost in an inefficient manner.

This system solution is very cost-efficient in terms of investment costs due to the fluid pumps, particularly in the form of at least one fixed-displacement pump, which can be obtained at low cost in each case; however, the operating costs are substantially higher, as the consumer regularly demands larger quantities of fluid volumes at higher pressure than are actually consumed.

In the known system solution according to FIG. 3, a circulating pressure compensator and a switching valve together with two fluid pumps are also used. In this variant, an attempt is made to save energy accordingly by dividing the total volume flow between two feed or fluid pumps in the closed-loop control system itself and switching a fluid pump to unpressurised circulation. Thus, at a predefinable, lower speed of the consumer, at which less delivery volume is required, one of the two fluid pumps can be switched off completely. In this respect, the third system solution is more energy-efficient than the variant according to FIG. 2 and can be implemented more cost-effectively than the variant according to FIG. 1. However, a closed-loop control system with sensors and electrical activation is required and thus, in terms of investment costs, the solution according to FIG. 3 is in turn more cost-intensive than the solution according to FIG. 2. Switching of the valve for unpressurised circulation is also much more demanding in terms of control technology, since the pressure compensator as a regulator is not permanently coupled to the closed-loop control system of the switching valve.

### SUMMARY

A need exists to provide an improved solution, in particular to create a supply device that is as reasonably priced, energy-efficient, and stable during operation.

The need is addressed by the subject matter of the independent claim(s). Embodiments of the invention are described in the dependent claims, the following description, and the drawings.

### BRIEF DESCRIPTION OF THE DRAWINGS

FIGS. 1, 2, and 3 show prior art solutions using a swivel angle pump, a circulating pressure compensator and a circulating pressure compensator with two switching valves; and

FIGS. 4 and 5 show components of the supply device according to some embodiments with three fixed-displacement pumps in an initial state and an operating state respectively.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, the respective outlet sides of the fluid pumps are connected to the inlet of the fluid supply by means of the open-loop control device, thereby bypassing the closed-loop control device, and that the respective closed-loop control device in the return feed line from the respective consumer releases a modifiable opening cross-section, which can be assigned to each of the outlet sides of the fluid pumps, to a low-pressure or return port means that, on the one hand, in contrast to swivel angle pumps, cost-efficient fixed-displacement pumps, such as gear pumps, can be used and, on the other hand, no special load-sensing regulators are required, such as directly-controlled power regulators. It is also possible to adjust the total power to the power actually required at the respective consumer using structurally simple open-loop and closed-loop control means. In this way, the fluid pumps are connected to a circulating pressure compensator in the form of the closed-loop control device, the fluid path of one pump as secondary pump is released first to the low-pressure side or to the tank and the fluid path of the respective other fluid pump serves as a permanent pump for the fluid supply. In this respect, this is a structurally simple, self-governing and robust supply device solution overall. In particular, the fluid supply device according to the teachings herein requires only one one-piece regulating piston so that the fluid flows can be controlled without delay or obstruction. The respective closed-loop control device releases a modifiable opening cross-section to a low-pressure or return port, which can be assigned to each of the fluid pumps, the opening cross-sections being adjusted during operation being different from one another in relation to a control specification.

In some embodiments of the supply device, it is provided that the closed-loop control device has a control valve with a regulating housing and a regulating piston, which is longitudinally displaceable therein, and that the regulating housing has a plurality of fluid inlets, to each of which a fluid pump can be assigned. In this way, the closed-loop control device is implemented as part of an overall block valve solution, it also being possible to divide the overall block into individual functions with individual valves.

In some embodiments of the supply device, it is provided that the individual opening cross-sections are bounded in pairs by control edges in the regulating piston and regulating housing and that, as the distance between the control edges of a pair increases, the associated opening cross-section increases accordingly, depending on the respective travel position of the regulating piston in the regulating housing in one direction. In this case, one control edge is defined in each case by the housing geometry of the regulating housing and the adjacent control edge of a pair is defined in each case by the geometry of the regulating piston. In a manner beneficially to control, a kind of cascade is achieved in this way, in which an opening cross-section is already steadily released, while, in contrast, a subsequent opening cross-section in the sequence is opened to a lesser extent or is still completely closed. Thanks to the aforementioned geometry of the open-loop or closed-loop control edges, the power supply for the hydraulic consumer is ensured for any requirement.

In some embodiments of the supply device, it is provided that the regulating piston is acted upon on its mutually opposing end faces by an energy accumulator, such as a compression spring, on the one hand, and by the fluid pressure at the inlet of the open-loop control device on the other hand. As a result, the regulating piston is located in a balanced home position within the regulating housing and can react quickly to changing control pressures on its opposing end faces and perform the cascade mentioned with different opening cross-sections.

In some embodiments of the supply device, it is provided that the regulating piston together with the regulating housing defines individual fluid chambers which are each co-formed by a diameter reduction in the regulating piston and that, when the opening cross-sections are closed, the fluid chambers are connected exclusively to the low-pressure or return port and, when the opening cross-sections are released, are additionally in fluid communication with the fluid supply device. It is for example further provided that each inlet for a fluid pump opens out in the regulating housing into an associated fluid channel, which opens out into an assigned fluid chamber when the opening cross-sections are released. In this way, the regulating housing with its regulating piston can be constructed modularly so that three or more fixed-displacement pumps can also be used as part of the fluid supply device in addition to the two fixed-displacement pumps originally envisaged. The fluid pressure required always corresponds to the load pressure when the respective fluid pump is required.

For example, it is further provided that a fluid channel in the manner r of a central channel leading via a fluid connection is connected to the respective hydraulic consumer and that the respective further fluid channels of the same type open into the central channel against the action of a check valve. By arranging a central channel in the control housing, almost any fluid volumes and fluid pressures originating from fixed-displacement pumps can be decoupled from each other within the regulating housing, which in turn benefits the control behaviour of the supply device as a whole. A branch line for example opens into the central channel downstream of the respective check valve, which branch line leads to the other end face of the regulating piston, which opposes the end face with the energy accumulator.

In some embodiments of the supply device, it is provided that a branch channel opens into the central channel downstream of the respective check valve, which branch channel leads to the other end face of the regulating piston, which opposes the end face with the energy accumulator, and receives the fluid pressure from the open-loop control device.

In some embodiments of the supply device, it is provided that an adjustable measuring orifice, as part of the open-loop control device, is connected in a: fluid connection to the hydraulic consumer and that a pump line originating from one of the fixed-displacement pumps opens into this fluid connection between this measuring orifice and the closed-loop control device.

The supply device can be used in a particularly beneficial manner for open hydraulic circuits; however, there are also meaningful applications in the context of closed circuits (not shown).

The supply device is discussed in greater detail below with reference to further embodiments according to the FIGS., which illustrate hydraulic circuit diagrams. The FIGS. are schematic and not necessarily to scale.

Specific references to components, process steps, and other elements are not intended to be limiting. Further, it is understood that like parts bear the same or similar reference numerals when referring to alternate FIGS. The FIGS. are schematic and not necessarily to scale.

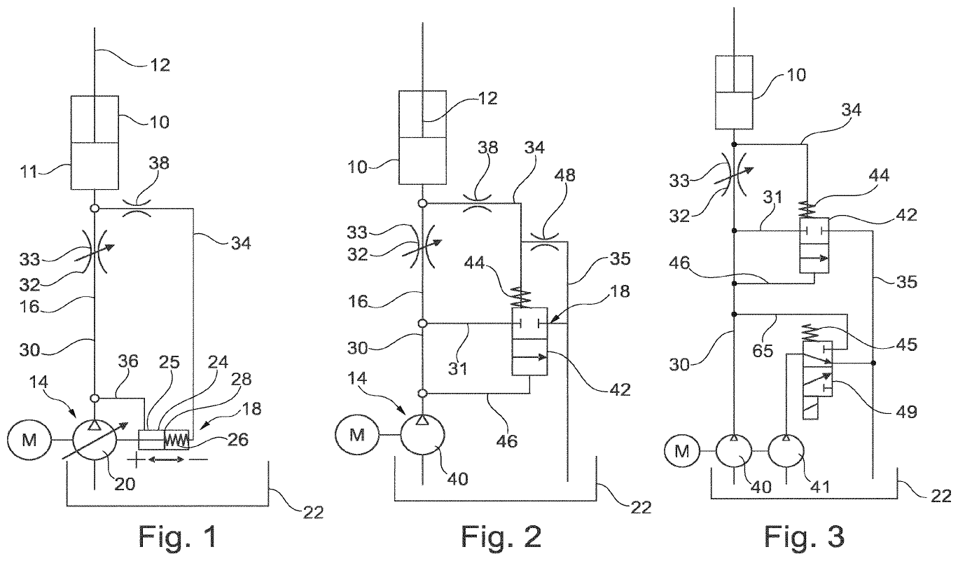

FIG. 1 shows a prior art supply device for at least one hydraulic consumer, here in the form of a conventional working cylinder 10, which is configured as a so-called differential cylinder and is provided with a piston-rod unit 12, which is guided so as to be longitudinally movable in a cylinder housing 11 in a correspondingly controlled manner, the piston-rod unit 12 assuming a central position in the housing 11 according to the diagram of FIG. 1. The aforementioned construction of working cylinders 10 is common, with the result that it will not be discussed in greater detail at this point. The supply device also has a fluid supply device denoted as a whole by 14, which is connected to a supply circuit 16 for the hydraulic consumer shown. Furthermore, there is a closed-loop control device denoted as a whole by 18, which controls the fluid supply to the respective consumer in the form of the working cylinder 10.

The fluid supply device 14 has a swivel angle pump 20 of conventional design, which draws fluid from a storage tank 22 during operation. The swivel angle pump 20 is driven in the usual manner by a motor M which can also be an electric motor of conventional design. A directly controlled power regulator 24 as part of the closed-loop control device 18 is used to control the swivel angle pump 20. At least one adjusting spring 26, which cooperates with an adjusting piston 28 to deflect the swivel angle pump 20, is located in the housing 25 of the power regulator 24 shown. The possible deflection positions of the adjusting piston 28 under the influence of the respective adjusting spring 26 are shown in FIG. 1 by a double arrow, and a plus and a minus sign is shown at the ends of the arrow to indicate the deflection position for an increased volume flow or a decreased volume flow. Consequently, the volume flow is controlled and the power is generated at the consumer or at the working cylinder 10.

The supply circuit 16 has a connecting line 30 between the outlet of the swivel angle pump 20 and the piston-side inlet of the cylinder housing 11 of the working cylinder 10. Connected in the aforementioned connecting line 30, there is a measuring orifice 33 with an adjustable free cross-section as part of an open-loop control device 32, with which the free volume flow in the direction of the working cylinder 10 can be specified and therefore its travel speed, particularly when the piston-rod unit 12 is extended. A control line 34 is connected between the measuring orifice 33 and the fluid inlet of the working cylinder 10, the other free end of which control line opens into the (spring) housing 25 of the power regulator 24 with the respective adjusting spring 26. A further control line 36 is connected on the piston-rod side with the adjusting piston 28 of the power regulator 24, which control line opens into the connecting line 30 on the outlet side of the swivel angle pump 20. For example, for the solution according to FIG. 1 (not shown), as illustrated for FIG. 2, there is a return line 35 to the tank 22, with a further orifice or restrictor 48, the return line 35 being connected to the control line 34 and otherwise having no further branch, such as the branch in FIG. 2, which leads to the valve 42 in the form of a pressure compensator.

Overall, the known solution according to FIG. 1 forms a so-called load-sensing controller which adjusts the pump delivery or volume flow to the power requirement of the hydraulic consumer in the form of the working cylinder 10. Furthermore, the control line 34 has an orifice or a restrictor 38 with a fixedly predetermined, free restrictor cross-section in the direction of the power regulator 24 for generating a pressure drop.

A notional working example is used for a better understanding of the solutions according to the FIGS. In this case, the investment costs are to be determined according to the purchase price and the operating costs based on the power P=p (pressure)*Q (volume flow). For the sake of simplicity, it is assumed for the embodiment examples that only one load is present which corresponds to a pressure at the consumer or at the working cylinder 10 of 100 bar. As a result, the power at the consumer is proportional to the volume flow at the consumer. The power of the fluid supply results from the pressure p and the volume flow Q downstream of the respective fluid pump. In this case, the variable displacement or swivel angle pump 20 should be able to provide a maximum flow rate of 100 l/min, around 50 l/min being required on the consumer side at the working cylinder 10. The required power of the consumer 10 then corresponds to the power at the fluid pump 20 plus the power loss via the measuring orifice 33. This results in a discharge pressure at the pump 20 of 110 bar, made up of the 100 bar at the consumer 10 and the 10 bar at the measuring orifice 33. The volume flow of the fluid pump 20 is thus Qpump=Qconsumer.

This results in an overall consideration for the motor M as follows

P=Qpump (50 l/min)*p (110 bar)

P=5,500 (units not converted); otherwise P (kw)=p (bar)*Q (l/min)/600

Consequently, the solution according to FIG. 1 can be regarded as very energy-efficient, but the swivel angle pumps 20 used are the most expensive pumps that can currently be used here.

FIG. 2 relates to a further, known prior art solution, the hydraulic components of the same design described so far being shown with the same reference numerals and the explanations given so far also applying to the modified embodiment according to FIG. 2. In a departure from the known solution according to FIG. 1, the supply device according to FIG. 2 has a fixed-displacement pump 40, for example in the form of a gear pump, which in turn is driven by a motor M, for example in the form of an electric motor.

In the embodiment according to FIG. 2, a circulating pressure compensator 42 is used as the regulator. The two mutually opposing control sides of the circulating pressure compensator 42 are acted upon by the spring force of a compression spring 44 and, together with this, the pressure acts in turn in the part of the control line 34 which is routed via the further restrictor 38. On the opposite side, the control pressure of the fixed-displacement pump 40 is applied on its outlet side via a further control line 46. The circulating pressure compensator 42, which is drawn in a simplified manner, is shown in FIG. 2 in its blocked position, in which a fluid connection 31 between the connecting line 30 and a return line 35, which opens into the storage tank 22 on the outlet side, is blocked. In addition, a further, third orifice or restrictor 48 is connected to the return line 35 in the aforementioned branch. In the activated state, the circulating pressure compensator 42 keeps the pressure difference across the measuring orifice 33 constant and when the measuring orifice 33 is completely closed, the pressure compensator 42 is fully open and the volume flow conveyed by the pump 40 circulates largely without pressure in the direction of the fluid storage tank 22. In this respect, however, there is always a pressure present in the system which corresponds at least to the spring force of the compression spring 44.

In this solution according to FIG. 2, the pump 40 always provides the maximum volume flow and the volume flow not required by the consumer 10 is discharged to the tank 22 via the circulating pressure compensator 42. This means that power which is not required is converted into heat, which is not very energy-efficient.

As a working example for the solution according to FIG. 2, a constant delivery volume of 100 l/min should be present on the outlet side of the pump 40, the consumer again requiring 50 l/min.

This results in a starting pressure for the fluid pump 40 of 110 bar, formed from the assumed 100 bar at the consumer and the 10 bar at the measuring orifice 33. The volume flow of the pump 40 corresponds to Qpump=Qmax, with an overall consideration for the motor M as follows:

P=Qpump (100 l/min)*p (110 bar); therefore

P=11,000 (units not converted).

The solution according to FIG. 2 has very low investment costs due to the competitively priced fluid pumps 40. However, the operating costs are significantly higher if, as in the case shown, only 50 l/min are required at 110 bar, but 100 l/min are actually consumed at 110 bar.

FIG. 3 shows a further prior art solution. Here again, the same components as described above are shown with the same reference numerals and the explanations given previously then also apply in this respect to the solution according to FIG. 3. The solution is constructed in a similar way to FIG. 2, a further, second fixed-displacement pump 41 being used which, together with the first fixed-displacement pump 40, is driven by the motor M. Connected on the outlet side of the further fixed-displacement pump 41 there is a switching valve 49 which, being electromagnetically operated and reset to a starting point by means of a compression spring 45, assumes its starting position shown in FIG. 3. In this case, the 3/2 directional-control valve is connected to the return line 35, which with its one end is connected to the outlet side of the pressure compensator 42 and with its other end opens into the storage tank 22.

In this variant according to FIG. 3, an attempt is made to save energy by dividing the total volume flow of 100 l/min between two fluid pumps 40, 41, where each fluid pump 40 or 41 delivers a constant 50 l/min, and by using a closed-loop control system and possible switching of the one fluid pump 41 to unpressurised circulation by means of the switching valve 49 in the position shown. If, due to the speed of the consumer or working cylinder 10, less than the predefinable delivery volume of 50 l/min is required at the consumer, one pump, in this case the fluid pump 41, can be switched off. If more volume is required at the consumer, the valve 49 is switched and fluid flows from the pump 41 to the consumer via the lines 65 and 30.

The solution according to FIG. 3 in the notional example is as efficient as the solution according to FIG. 1 at exactly 50 l/min. For all volume flows at the consumer >50 l/min, the output is P=11,000 corresponding to the solution in FIG. 2. For all volume flows at the consumer <50 l/min, the result is an output corresponding to the solution shown in FIG. 2, divided by two, which results in P=5,500.

Consequently, the solution shown in FIG. 3 is more energy-efficient than the solution shown in FIG. 2 and more reasonably priced than the solution shown in FIG. 1. However, a closed-loop control system with sensors together with electrical activation is required, which is not shown in FIG. 3, and thus the solution according to FIG. 3 is more cost-intensive than the solution according to FIG. 2 in terms of investment costs. Switching of the valve 49 for unpressurised circulation is also more demanding in terms of control technology, since the pressure compensator 42 as a regulator is not permanently coupled to the closed-loop control system of the switching valve 49.

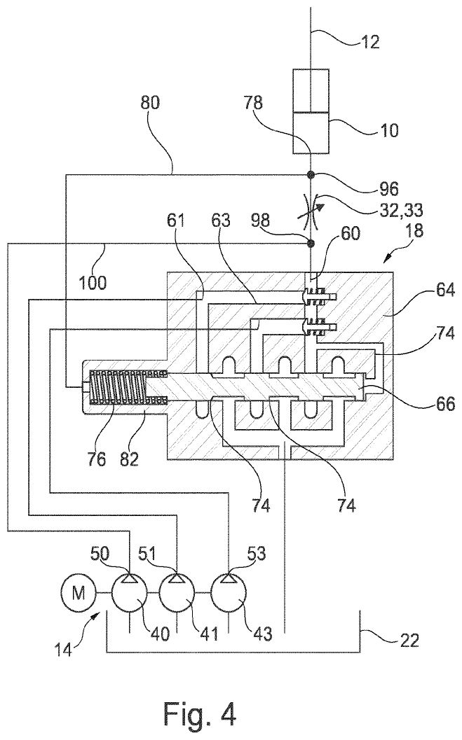

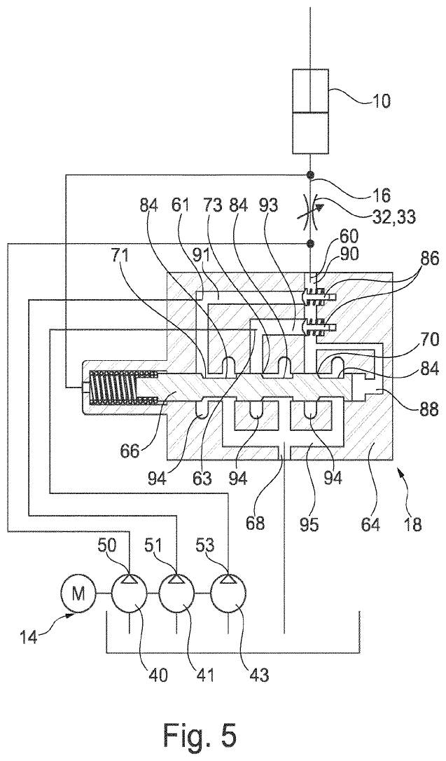

That being said, a solution according to the teachings herein is now presented with reference to FIGS. 4 and 5, which is almost as energy-efficient as the solution according to FIG. 3 and almost as reasonably priced as the solution according to FIG. 2.

In this case, again, the same hydraulic components as shown above are denoted by the same reference numerals in FIG. 1 to 3 and the previous explanations given then also apply in this respect for the solution according to the teachings herein shown in FIGS. 4 and 5.

The fluid supply device 14 now has three fluid pumps 40, 41, 43, for example, each with a constant volume flow on their associated outlet sides 50, 51, 53. These are also fixed-displacement pumps, gear pumps for example, which are driven by a common drive, i.e. a motor M. Particularly for example, an electric motor should also be used again here; however, other types of drive are also conceivable, such as a diesel engine.

The respective outlet sides 50, 51, 53 are connected to various assigned inlets 60, 61, 63 of the regulating housing 64 of the closed-loop control device 18 in such a manner that a regulating piston 66 of the said closed-loop control device 18, which is arranged so as to be longitudinally displaceable in the regulating housing 64, releases an opening cross-section 70, 71, 73 assignable to each fluid pump 40, 41, 43, to a tank port or return port 68 under the control of a control pressure upstream and downstream of the measuring orifice 33 of the open-loop control device 32 with respect to the regulating housing 64 and which, viewed in the direction of FIGS. 4 and 5, opens out into the storage tank 22 at the bottom via a corresponding connecting line. Since FIG. 4 presents a starting state for the supply device, the aforementioned variable, partially released opening cross-sections 70, 71, 73 during operation of the supply device are only shown in this respect by way of example in FIG. 5. Thus, in the operating position shown in FIG. 5, the first opening cross-section 70 is closed, the further opening cross-section 71 is the widest open and the third opening cross-section 73 is in a position between the widest open position 71 and the closed position 70. In this respect, the opening cross-sections 70, 71, 73, which are adjusted in each case during operation, are different from one another and are completely closed in the starting position of the supply device according to FIG. 3. The present description that one opening cross-section is wider open than the other is correct if fluid pumps 40, 41, 43 of the same size are used. However, the design actually takes different pump sizes into account. In any case, in order to maintain cascading, it is necessary for one opening cross-section to open before another.

As can further be seen from FIGS. 4 and 5, the individual opening cross-sections 70, 71, 73 are bounded in pairs by circumferential control edges 74 on the regulating piston 66 and on the regulating housing 64, only the control edges of the housing 64 being denoted by 74 in FIG. 4 for the sake of simplicity. As the distance between the associated control edges 74 of a pair increases, the associated opening cross-section 70, 71, 73 also increases, as shown in FIG. 5. Thus, in the manner of a cascade, one opening cross-section 70 is already steadily released during operation, while, in contrast, a subsequent opening cross-section 73 in the sequence is opened to a lesser extent and the third opening cross-section 71 is still completely closed. It is understood that to the extent that the third opening cross-section 70 opens, the two other opening cross-sections 71, 73 accordingly increase equally in terms of their free cross-section. To obtain the individual opening cross-sections 70, 71, 73, the regulating piston 66 is acted upon, on the one hand, on its mutually opposing end faces by an energy accumulator, such as at least one compression spring 76, and the fluid pressure at the point 96 upstream of the inlet 78 of the respective hydraulic consumer and, on the other hand, at least partially by the fluid pressure of the fluid supply device 14 which will be explained in greater detail. In this respect, a connecting line 80 is routed between the connection point 96 and parts 82 of the regulating housing 64, which accommodate the respective compression spring 76 and parts of the longitudinally displaceable regulating piston 66.

The regulating piston 66 together with the regulating housing 64 at least partially defines individual fluid chambers 84, which are each co-formed by a diameter reduction in the regulating piston 66. In this way, when the opening cross-sections 70, 71, 73 are closed, the fluid chambers 84 are connected exclusively to the tank port or return port 68 as shown in FIG. 4 and, when the opening cross-sections 70, 71, 73 are released, they are additionally connected to the fluid supply device 14 according to the diagram of FIG. 5.

As can further be seen from FIGS. 4 and 5, each inlet 60, 61, 63 for a fluid pump 50, 51 53 opens out in the regulating housing 64 into an associated fluid channel 90, 91, 93, which opens out into an adjacent assigned fluid chamber 84 in each case when the opening cross-sections 70, 71, 73 are released accordingly. One of the fluid channels, namely the fluid channel 90, forms a type of central channel and is routed in vertical orientation in the regulating housing 64 according to the diagram of FIGS. 4 and 5. The other fluid channels 91 and 93 open out into the aforementioned central channel 90 in an angled or curved shape and one above the other, said fluid channels each opening out at their other free end, like the channel 90, into an annular extension 94 in the regulating housing 64, along which annular extension the regulating piston 66 is guided. A spring-loaded check valve 86 is connected at the point where the fluid channels 91, 93 transition into the central channel 90, said check valve opening against the spring action as soon as the fluid pressure counter to the spring action in the respective fluid channel 91, 93 is higher than the fluid pressure present in the channel 90. Furthermore, a branch channel 88, starting from the central channel 90 below the two check valves 86, leads to the free end face of the regulating piston 66, which is opposite the opposing end face with the respective compression spring 76. Further fluid channels 95 are in fluid communication with the fluid channels 90, 91, 93 when the opening cross-sections 70, 71, 73 are released and open out at the bottom into the tank port or return port 68, which is connected to the storage tank 22 in a fluid-conducting manner. In this respect, a supply device for at least one hydraulic consumer, such as a working cylinder 10, is thus created according to the teachings herein, with a fluid supply device 14, which is connected to a supply circuit 16, which has at least two fluid pumps 40, 41, 43, for the respective hydraulic consumer, with an open-loop control device 32, which controls the fluid supply to the respective hydraulic consumer in the inlet, and with at least one closed-loop control device 18, the respective outlet sides 50, 51, 53 of the fluid pumps 40, 41, 43 being connected to the inlet of the fluid supply by means of the open-loop control device 32, thereby bypassing the closed-loop control device 18, and the respective closed-loop control device 18 in the return feed line from the respective consumer releasing a modifiable opening cross-section 70, 71, 73, which can be assigned to each of the outlet sides 50, 51, 53 of the fluid pumps 40, 41, 43, to a low-pressure or return port 68.

The measuring restrictor 33 already presented is connected between an outlet-side connection point 96 of the connecting line 80 and an inlet-side connection point 98 of a connecting line 100 to the first fixed-displacement pump 50, which leads to the inlet side 60 of the control housing 64.

The supply device according to the diagram of FIGS. 4 and 5 is also used as part of an open circuit and it is understood that the regulating housing 64 together with the regulating piston 66 is only illustrated in a very basic manner and details, such as housing halves and housing closure parts, are disregarded for the sake of better illustration.

The supply device can also be operated with only two fixed-displacement pumps 50, 51 or 51, 53 and 50, 53, in which case one of the assignable fluid channels 90, 91, 93 can then be omitted, and it is also possible to control the respective hydraulic consumer with more than three fixed-displacement pumps of the supply device, in which case more fluid channels together with check valves must then be provided accordingly.

To be able to make a better comparison with the solution according to FIG. 3, the solution according to the teachings herein is only compared insofar as two fluid pumps are to be used, as already explained, which in this respect are connected to the circulating pressure compensator in the form of the closed-loop control device 18 as a whole. In this case, the fluid path of the one pump, which acts as a secondary pump, is released to the storage tank sooner than the fluid path of the other pump, which acts as a permanent pump. The additional check valve(s) 86 also generate a pressure loss, but this is in the lower range and experience has shown that it is between 1 and 3 bar and can therefore be considered low compared to the 110 bar at the consumer.

In the case of the two pumps to be used, one fluid pump should have a delivery volume of 50 l/min and the other pump should likewise have a delivery volume of 50 l/min. Closed-loop control takes place via the control edge of the circulating pressure compensator assigned to the permanent pump for all volume flows at the consumer or at the working cylinder 10 greater than 50 l/min. In this case, a control edge assigned to the secondary pump is adjusted to a larger opening cross-section and in this respect is switched to “unpressurised” circulation. In this respect, the power requirement is then slightly worse than in the solution according to FIG. 3 with switched valve 49, but is significantly better than in the solution according to FIG. 2. The smaller the volume flow at the consumer, the sooner the power at the motor corresponds to the value P=5,500.

For all volume flows at the consumer greater than 50 l/min, the control edge of the circulating pressure compensator assigned to the secondary pump then controls and the control edge assigned to the permanent pump is closed. The power requirement for this operating state then corresponds to the power requirement of the solution according to FIG. 2 and/or the solution according to FIG. 3, with the valve not switched; i.e. P=11,000. As shown, the investment costs are lower than in the solution according to FIG. 3, but slightly higher than in the solution according to FIG. 2. There is no need to coordinate the two closed-loop control circuits for the circulating pressure compensator 42 and the switching valve 49.

Irrespective of the previous solutions described with identical pumps 40, 41, 43 according to the diagram of FIGS. 4 and 5, it makes perfect sense to adapt the fluid pumps to typical operating conditions. This applies to both the size of the fluid pumps and to the order in which they are arranged. The respective opening cross-section at the circulating pressure compensator in the form of the closed-loop control device 18 can also be adjusted to the respective pump size. In this case, a large pump is described by G, a medium pump by M and a small pump by K, with the following combinations: G-M-K; M-K-G; K-M-G; K-G-M etc. With a supply device as described in FIGS. 4 and 5, if necessary the hydraulic pump output of at least two fluid pumps can be kept constant for a hydraulic consumer by means of the circulating pressure compensator in the form of the closed-loop control device 18, in a similar way to the prior art solutions according to FIG. 1 to 3, power losses during pump operation being prevented, as is delayed control behaviour for the hydraulic consumer, even if it is subjected to a load. It is understood that the hydraulic consumer need not only consist of a single working cylinder 10, but that a plurality of actuators, including in the form of hydraulic motors, can form the hydraulic consumer.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the function of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-11. (canceled)

12. A supply device for at least one hydraulic consumer, such as a working cylinder, comprising a fluid supply device, which is connected to a supply circuit that has at least two fluid pumps, for the respective hydraulic consumer, an open-loop control device which controls the supply of fluid to the respective hydraulic consumer in the inlet, and at least one closed-loop control device, wherein the respective outlet sides of the fluid pumps are connected to the inlet of the fluid supply using the open-loop control device, thereby bypassing the closed-loop control device, and wherein the respective closed-loop control device in the return feed line from the respective consumer releases a modifiable opening cross-section, which can be assigned to each of the outlet sides of the fluid pumps, to a low-pressure or return port.

13. The supply device of claim 12, wherein the closed-loop control device has a control valve with a regulating housing and a regulating piston, which is longitudinally displaceable therein, and wherein the regulating housing has a plurality of fluid inlets, to each of which a fluid pump can be assigned.

14. The supply device of claim 12, wherein the individual opening cross-sections are bounded in pairs by control edges in the regulating piston and regulating housing and wherein, as the distance between the control edges of a pair increases, the associated opening cross-section increases accordingly, depending on the respective travel position of the regulating piston in the regulating housing in one direction.

15. The supply device of claim 12, wherein one opening cross-section is already steadily released in the manner of a cascade and, in contrast, a subsequent opening cross-section in the sequence is opened to a lesser extent or is still completely closed.

16. The supply device of claim 12, wherein, on the one hand, the regulating piston is acted upon on its mutually opposing end faces by an energy accumulator, such as a compression spring and, on the other hand, by the fluid pressure at the inlet or outlet of the open-loop control device.

17. The supply device of claim 12, wherein the regulating piston together with the regulating housing defines individual fluid chambers, which are each co-formed by a diameter reduction in the regulating piston, and wherein, when the opening cross-sections are closed, the fluid chambers are connected exclusively to the low-pressure or return port and, when the opening cross-sections are released, are additionally in fluid communication with the fluid supply device.

18. The supply device of claim 12, wherein each inlet for a fluid pump opens out in the regulating housing into an associated fluid channel, which opens out into an assigned fluid chamber when the opening cross-sections are released.

19. The supply device of claim 12, wherein, when the opening cross-sections are released, the respective fluid channel opens out via the assignable fluid chamber into an adjacent further fluid channel, which leads to the low-pressure or return port.

20. The supply device of claim 12, wherein one fluid channel leading via a fluid connection is connected to the respective hydraulic consumer in the manner of a central channel, and wherein the respective further fluid channels of the same type open into the central channel against the action of a check valve.

21. The supply device of claim 12, wherein a branch channel opens out into the central channel downstream of the respective check valve, which branch channel leads to the other end face of the regulating piston, which opposes the end face with the energy accumulator, and receives the fluid pressure from the open-loop control device.

22. The supply device of claim 12, wherein an adjustable measuring restrictor, as part of the open-loop control device, is connected in a fluid connection to the hydraulic consumer and wherein a pump line originating from one of the fluid pumps opens into this fluid connection between this measuring restrictor and the closed-loop control device.

23. The supply device of claim 13, wherein the individual opening cross-sections are bounded in pairs by control edges in the regulating piston and regulating housing and wherein, as the distance between the control edges of a pair increases, the associated opening cross-section increases accordingly, depending on the respective travel position of the regulating piston in the regulating housing in one direction.

24. The supply device of claim 13, wherein one opening cross-section is already steadily released in the manner of a cascade and, in contrast, a subsequent opening cross-section in the sequence is opened to a lesser extent or is still completely closed.

25. The supply device of claim 14, wherein one opening cross-section is already steadily released in the manner of a cascade and, in contrast, a subsequent opening cross-section in the sequence is opened to a lesser extent or is still completely closed.

26. The supply device of claim 13, wherein, on the one hand, the regulating piston is acted upon on its mutually opposing end faces by an energy accumulator, such as a compression spring and, on the other hand, by the fluid pressure at the inlet or outlet of the open-loop control device.

27. The supply device of claim 14, wherein, on the one hand, the regulating piston is acted upon on its mutually opposing end faces by an energy accumulator, such as a compression spring and, on the other hand, by the fluid pressure at the inlet or outlet of the open-loop control device.

28. The supply device of claim 15, wherein, on the one hand, the regulating piston is acted upon on its mutually opposing end faces by an energy accumulator, such as a compression spring and, on the other hand, by the fluid pressure at the inlet or outlet of the open-loop control device.

29. The supply device of claim 13, wherein the regulating piston together with the regulating housing defines individual fluid chambers, which are each co-formed by a diameter reduction in the regulating piston, and wherein, when the opening cross-sections are closed, the fluid chambers are connected exclusively to the low-pressure or return port and, when the opening cross-sections are released, are additionally in fluid communication with the fluid supply device.

30. The supply device of claim 14, wherein the regulating piston together with the regulating housing defines individual fluid chambers, which are each co-formed by a diameter reduction in the regulating piston, and wherein, when the opening cross-sections are closed, the fluid chambers are connected exclusively to the low-pressure or return port and, when the opening cross-sections are released, are additionally in fluid communication with the fluid supply device.

31. The supply device of claim 15, wherein the regulating piston together with the regulating housing defines individual fluid chambers, which are each co-formed by a diameter reduction in the regulating piston, and wherein, when the opening cross-sections are closed, the fluid chambers are connected exclusively to the low-pressure or return port and, when the opening cross-sections are released, are additionally in fluid communication with the fluid supply device.
